(19) United States
(12) Patent Application Publication
(10) Pub. No.: US 2002/0129147 A1
(43) Pub. Date: Sep. 12, 2002

(54) Communication terminal capable of automatically switching between communication modes

(76) Inventor: Masahide Ogasawara, Nagoya-City (JP)

Correspondence Address: FISH & RICHARDSON, PC, 4350 LA JOLLA VILLAGE DRIVE, SUITE 500, SAN DIEGO, CA, 92122, US

(21) Appl. No.: 10/094,190

(22) Filed: Mar. 8, 2002

(30) Foreign Application Priority Data
Mar. 9, 2001 (JP) 2001-66932

(51) Int. Cl. G06F 15/173

(52) U.S. Cl. 709/225

(57) ABSTRACT

In a personal digital assistant (PDA), a communication section receives a data signal from a communication network in a packet-switched communication (PSC) mode or a circuit-switched communication (CSC) mode. In the PDA, a data amount acquisition block acquires information on the amount of the remaining data of the data signal. A PSC charge estimator block calculates an estimated PSC charge assuming that the remaining data of the amount indicated by the acquired information is received in the PSC mode. A CSC charge estimator block calculates an estimated CSC charge assuming that the remaining data is received in the CSC mode. The estimated PSC charge and the estimated CSC charge are compared, and the communication section is set in a communication mode which is selected from the PSC mode and the CSC mode based on the result of the comparison.

### CROSS REFERENCE TO RELATED APPLICATION

The present application is based on and incorporates herein by reference Japanese Patent Application No. 2001-66932 filed on Mar. 9, 2001.

### BACKGROUND OF THE INVENTION

1. Field of the Invention

The present invention relates to a communication system in which a communication terminal receives a data signal from a communication network.

2. Related Art

Nowadays it is common for people to download data from a communication network. In such a communication system, a communication terminal such as a personal digital assistant (PDA) transmits a request signal that designates the desired content such as news, a weather forecast, a timetable, a map or financial news to the communication network. Then the communication network receives the request signal, and transmits a data signal that includes the requested content to the communication terminal.

As a switching system employed by such a communication system, a store-and-forward switching system and a circuit switching system are known. The store-and-forward switching system is typified by a packet switching system or a frame relay switching system. The store-and-forward switched communication system usually employs a data rate system which charges for the amount of transferred data. On the other hand, the circuit-switched communication system usually employs a time rate system which charges for time taken for communication.

Therefore store-and-forward switched communication may be more economical in some cases, while circuit-switched communication may be more economical in other cases. However, the communication terminal should receive the data signal in a predetermined one of a store-and-forward switched communication (SSC) mode and a circuit-switched communication (CSC) mode, even if it is more expensive. This brings an economical disadvantage to the user of the communication terminal.

### SUMMARY OF THE INVENTION

The present invention has an object to provide a communication terminal which can automatically switch between communication modes so that the user of the communication terminal may obtain the data inexpensively.

The communication terminal according to the present invention includes data receiver means, data amount acquisition means, SSC charge estimator means, duration estimator means, CSC charge estimator means and comparator means. The data receiver means receives a data signal from a communication network in at least one of a store-and-forward switched communication (SSC) mode and a circuit-switched communication (CSC) mode. The data amount acquisition means acquires information on the amount of the data of the data signal. The SSC charge estimator means calculates an estimated SSC charge based on a relationship between an amount of transferred data and a communication charge assuming that the data of the amount indicated by the information acquired by the data amount acquisition means is received in the SSC mode.

On the other hand, the duration estimator means calculates estimated communication duration, which is time required for receiving the data of the amount indicated by the information acquired by the data amount acquisition means, based on a communication speed at which circuit-switched communication is performed between the data receiver means and the communication network. The CSC charge estimator means calculates an estimated CSC charge corresponding to the estimated communication duration based on a relationship between communication duration and a communication charge. The comparator means compares the estimated SSC charge and the estimated CSC charge. The data receiver is set in a communication mode which is selected from the SSC mode and the CSC mode based on the result of the comparison made by the comparator means.

Preferably, the communication terminal further includes RSS acquisition means and speed estimator means. The RSS acquisition means acquires information on received signal strength (RSS) at the time of reception of the data signal. The speed estimator means calculates an estimated communication speed using the acquired information on the RSS based on a relationship between RSS and a possible communication speed. The duration estimator means uses the estimated communication speed as the communication speed at which circuit-switched communication is performed, when it calculates the estimated communication duration.

### BRIEF DESCRIPTION OF THE DRAWINGS

The above and other objects, features and advantages of the present invention will become more apparent from the following detailed description made with reference to the accompanying drawings. In the drawings:

FIG. 1 is a functional block diagram showing a communication terminal according to an embodiment of the present invention;

FIGS. 2A-2C are schematic diagrams showing examples of tables held by the control section of the communication terminal;

FIG. 3 is a flowchart of a process executed by the control section of the communication terminal; and

FIG. 4 is a flowchart of a charge calculation process executed at steps 40 and 120 of FIG. 3.

### DETAILED DESCRIPTION OF THE PREFERRED EMBODIMENT

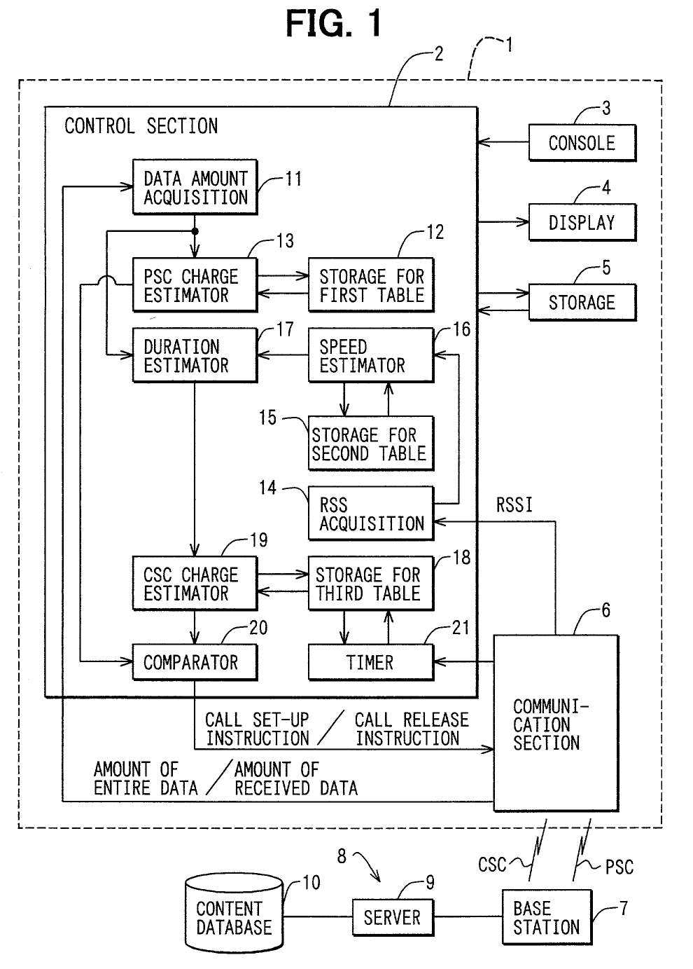

A communication terminal according to an embodiment of the present invention is used as a PDA. Referring to FIG. 1, the PDA 1 includes a control section 2 as control means and a communication section 6 as data receiver means. The PDA 1 further includes a console section 3, a display section 4 and a storage section 5. The main part of the control section 2 is a microcomputer, and the other components 3, 4, 5, 6 are connected to the control section 2.

The console section 3 is a keyboard on which various keys are arranged. If any of the keys is depressed, the console section 3 outputs a detection signal which indicates that the keystroke is detected. The display section 4 is a Liquid Crystal Display (LCD). When the display section 4 receives a display instruction from the control section 2, it displays information based on the display instruction. The storage section 5 stores programs, which are executed by the control section 2.

The PDA 1 belongs to a communication system which further includes a communication network 8. The communication network 8 includes a base station (switching center) 7, a server 9, and a content database 10. The content database 10 stores content such as news, a weather forecast, a timetable, a map and financial news.

The communication section 6 operates in two modes, that is, a packet-switched communication (PSC) mode and a circuit-switched communication (CSC) mode so as to be able to communicate with the communication network 8 according to the packet-switching system and the circuit-switching system, respectively. When the communication section 6 receives a call set-up instruction from the control section 2, it establishes a call between the communication section 6 and the base station 7. When the communication section 6 receives a call release instruction from the control section 2, it clears the call.

Specifically, when the communication section 6 receives a PSC call set-up instruction from the control section 2, it establishes a PSC call between the communication section 6 and the base station 7 so as to be able to perform packet-switched communication with the base station 7. When the communication section 6 receives a PSC call release instruction from the control section 2, it clears the PSC call so as not to be able to perform packet-switched communication with the base station 7.

On the other hand, when the communication section 6 receives a CSC call set-up instruction from the control section 2, it establishes a CSC call between the communication section 6 and the base station 7 so as to be able to perform circuit-switched communication with the base station 7. When the communication section 6 receives a CSC call release instruction from the control section 2, it clears the CSC call so as not to be able to perform circuit-switched communication with the base station 7.

The PDA 1 transmits a request signal that designates the desired content. The base station 7 receives the request signal and transmits it to the server 9. Then the server 9 receives the request signal, and retrieves the requested content from the content database 10. The server 9 transmits a data signal that includes the retrieved content to the base station 7. The base station 7 receives the data signal, and transmits it to the PDA 1.

The communication section 6 receives the data signal from the base station 7 according to HyperText Transfer Protocol (HTTP) Therefore it can obtain information on the amount of the entire data, which the base station 7 plans to transmit, based on the information which is retrieved from a predetermined field of the data signal and decoded. The obtained information on the amount of the entire data is outputted to the control section 2. Further the communication section 6 can obtain information on the amount of data that has been already received from the base station 7. The obtained information on the amount of received data is also outputted to the control section 2.

The control section 2 includes a data amount acquisition block 11, a first storage 12, a PSC charge estimator block 13, an RSS acquisition block 14, a second storage 15, a speed estimator block 16, a duration estimator block 17, a third storage 18, a CSC charge estimator block 19, a comparator block 20 and a timer block 21.

The data amount acquisition block 11 receives, from the communication section 6, the information on the amount of the entire data the base station 7 plans to transmit and the information on the amount of data which has been already received from the base station 7. Then the data amount acquisition block 11 acquires the information on the amount of the remaining data to be received using the information on the amount of the entire data and the information on the amount of the received data. The acquired information on the amount of the remaining data is outputted to the PSC charge estimator block 13 and the duration estimator block 17.

If the server 9 comes to have to transmit additional content to the PDA 1 in the middle of transmission of the data signal, this is reflected in the information on the amount of the entire data. Thus the information on the amount of the entire data varies depending on changes in the amount of the content that should be transmitted. Accordingly the data amount acquisition block 11 therefore the PDA 1 can adapt to the changes in the amount of the entire data the base station 7 plans to transmit.

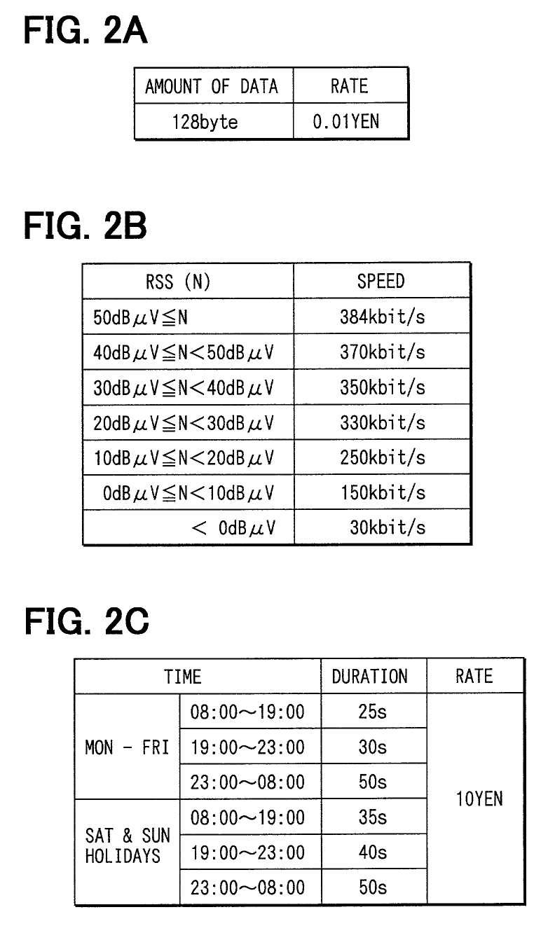

The first storage 12 stores a first table which includes a communication rate corresponding to a unit amount of transferred data as shown in FIG. 2A. The PSC charge estimator block 13 calculates, by referring to the first table, an estimated PSC charge assuming that the remaining data of the amount indicated by the information acquired by the data amount acquisition block 11 is received in the PSC mode. The estimated PSC charge is outputted to the comparator block 20.

The RSS acquisition block 14 acquires information on the received signal strength (RSS) at the time of reception of the data signal based on the Received Signal Strength Indicator (RSSI) provided by the communication section 6. The information on the RSS is outputted to the speed estimator block 16. The second storage 15 stores a second table which includes possible communication speeds corresponding to the respective ranges of the RSS as shown in FIG. 2B. The speed estimator block 16 calculates, by referring to the second table, an estimated communication speed corresponding to the RSS indicated by the information acquired by the RSS acquisition block 14. The estimated communication speed is outputted to the duration estimator block 17.

The duration estimator block 17 calculates, based on the estimated communication speed, estimated communication duration which is time required for receiving the remaining data of the amount indicated by the information acquired by the data amount acquisition block 11. The estimated communication duration is outputted to the CSC charge estimator block 19. The third storage 18 stores a third table which includes communication rates corresponding to unit duration for the respective time slots as shown in FIG. 2C. The CSC charge estimator block 19 calculates, by referring to the third table using the estimated communication duration, an estimated CSC charge assuming that the remaining data of the amount indicated by the information acquired by the data amount acquisition block 11 is received in the CSC mode. The estimated CSC charge is outputted to the comparator block 20.

The comparator block 20 compares the estimated PSC charge received from the PSC charge estimator block 13 and the estimated CSC charge received from the CSC charge estimator block 19. The timer block 21 begins to measure the elapsed time, when it receives, from the communication section 6, a signal which indicates that the CSC call is established between the communication section 6 and the base station 7. Thus the timer block 21 measures the current duration of the circuit-switched communication.

The control section 2 determines whether the current duration measured by the timer block 21 approaches an integral multiple of the unit duration stored in the third table. Specifically, the control section 2 determines whether the current duration reaches one of predetermined time lengths which are slightly less than integral multiples of the unit duration.

For example, when the remaining data is received at a time between 19:00 and 23:00 on a weekday, the integral multiple of the unit duration (i.e., the unit duration multiplied by n, where n is a positive integer) is 30s, 60s, 90s or the like. In this case the control section 2 determines whether the current duration reaches a time length that is less than 30s, 60s, or 90s by, for example, one second. That is, the control section 2 determines whether the current duration reaches 29s, 59s, 89s or the like. One second is time required for clearing the CSC call.

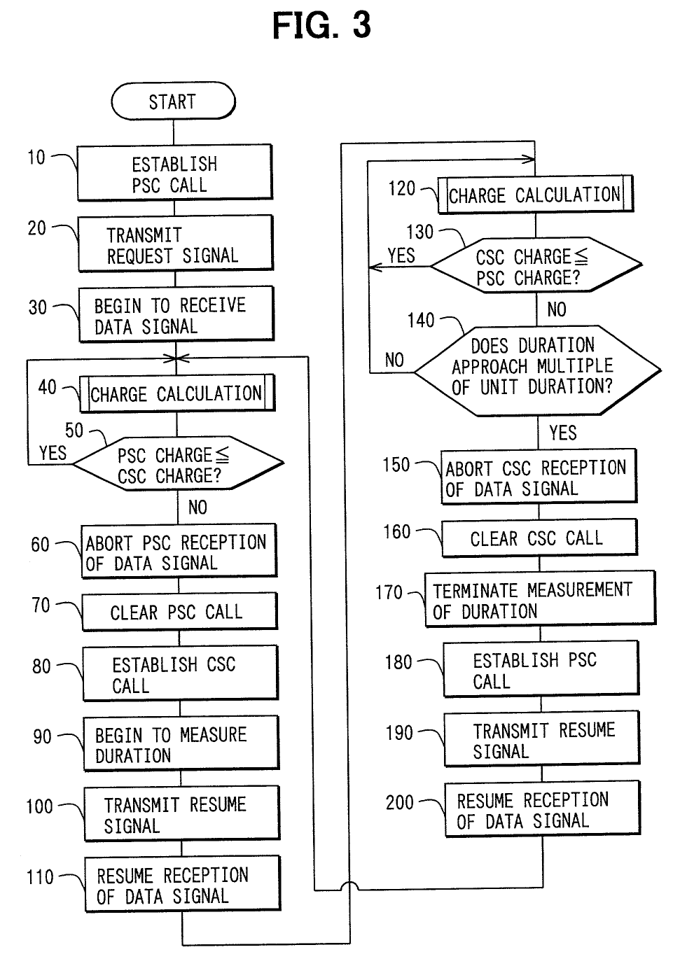

More specifically, the control section 2 executes the programs, which is stored in the storage section 5 and includes the programs for implementing the blocks 11-21, so as to operate as follows. Referring to FIG. 3, the control section 2 gives the communication section 6 a PSC call set-up instruction to establish a PSC call between the communication section 6 and the base station 7 at step 10, when it receives a detection signal which indicates that a predetermined key of the console section 3 is depressed for triggering transmission of a request signal.

In response to the PSC call set-up instruction, the communication section 6 establishes a PSC call between the communication section 6 and the base station 7. Then, at step 20, the control section 2 instructs the communication section 6 to transmit the request signal to the base station 7 in the PSC mode. The base station 7 receives the request signal, and transmits it to the server 9. The server 9 receives the request signal, and retrieves the content that is designated by the request signal from the content database 10. Then the server 9 transmits a data signal that includes the retrieved content to the base station 7.

The base station 7 receives the data signal, and begins to transmit it to the PDA 1. In this case, the base station 7 transmits the data signal according to the packet-switching system, since the PSC call has been established between the PDA 1 and the base station 7 at step 10. The control section 2 of the PDA 1 then instructs the communication section 6 to receive the data signal in the PSC mode at step 30. Thereafter the process proceeds to step 40. A charge calculation process is executed at step 40 as follows, so that a communication charge in the case that the data signal is received in the PSC mode and a communication charge in the case that the data signal is received in the CSC mode are estimated.

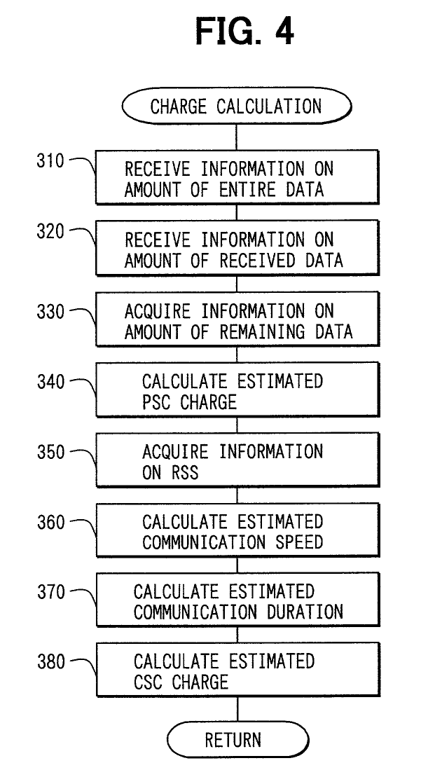

Referring to FIG. 4, at step 310, the data amount acquisition block 11 of the control section 2 receives, from the communication section 6, the information on the amount of the entire data the base station 7 plans to transmit. Next at step 320, the data amount acquisition block 11 receives, from the communication section 6, the information on the amount of data which has been already received from the base station 7. The data amount acquisition block 11 subtracts the amount of received data from the amount of the entire data at step 330, so as to acquire information on the amount of the remaining data to be received.

At step 340, the PSC charge estimator 13 of the control section 2 calculates, by referring to the first table stored in the first storage 12, an estimated PSC charge assuming that the remaining data of the amount indicated by the information acquired by the data amount acquisition block 11 is received in PSC mode from the base station 7.

At step 350, the RSS acquisition block 14 of the control section 2 acquires information on the RSS based on the RSSI provided by the communication section 6. At step 360, the speed estimator block 16 of the control section 2 calculates, by referring to the second table stored in the second storage 15, an estimated communication speed corresponding to the RSS indicated by the information acquired by the RSS acquisition block 14. That is, the speed estimator block 16 calculates the estimated communication speed at which circuit-switched communication is performed when the remaining data is received in the CSC mode from the base station 7.

At step 370, the duration estimator block 17 of the control section 2 calculates estimated communication duration which is time required for receiving the remaining data in the CSC mode at the estimated communication speed. At step 380, the CSC charge estimator block 19 of the control section 2 calculates, by referring to the third table stored in the third storage 18 using the estimated communication duration, an estimated CSC charge assuming that the remaining data of the amount indicated by the information acquired by the data amount acquisition block 11 is received in the CSC mode from the base station 7. Then the charge calculation process terminates.

Returning to FIG. 3, at step 50, the comparator block 20 of the control section 2 compares the estimated PSC charge, which is calculated by the PSC charge estimator block 13 assuming that the communication section 6 receives the remaining data of the amount indicated by the information acquired by the data amount acquisition block 11 in the PSC mode from the base station 7, and the estimated CSC charge, which is calculated by the CSC charge estimator block 19 assuming that the communication section 6 receives the remaining data in the CSC mode from the base station 7.

If the control section 2 determines that the estimated PSC charge is equal to or less than the estimated CSC charge, the process returns from step 50 to step 40 along the “YES” branch to execute the charge calculation process shown in FIG. 4 again. If the control section 2 determines that the estimated PSC charge is larger than the estimated CSC charge, the process proceeds from step 50 to step 60 along the “NO” branch.

The control section 2 interrupts the communication section 6 at step 60 to abort the PSC reception of the data signal. At step 70, the control section 2 gives the communication section 6 a PSC call release instruction. In response to the PSC call release instruction, the communication section 6 clears the PSC call that has been established at step 10 (or step 180) between the communication section 6 and the base station 7.

At step 80, the control section 2 gives the communication section 6 a CSC call set-up instruction. In response to the CSC call set-up instruction, the communication section 6 establishes the CSC call between the communication section 6 and the base station 7, and then outputs a signal, which indicates that the CSC call is established, to the control section 2. In response to the signal, at step 90, the control section 2 instructs the timer block 21 to begin to measure the elapsed time, that is, the current duration of the circuit-switched communication. At step 100, the control section 2 instructs the communication section 6 to resume the reception of the data signal. Then the communication section 6 transmits a resume signal to the base station 7 in the CSC mode.

The base station 7 receives the resume signal, and then resumes transmitting the data signal to the PDA 1. In this case, the base station 7 transmits the data signal according to the circuit-switching system, since the CSC call has been established between the PDA 1 and the base station 7 at step 80. Then, at step 110, the control section 2 instructs the communication section 6 to receive the data signal in the CSC mode, and thereafter the process proceeds to step 120 to execute the charge calculation process shown in FIG. 4 again.

At step 120, the data amount acquisition block 11 acquires the amount of the current remaining data, that is, the amount of the data that has not been received yet. Furthermore, the PSC charge estimator block 13 calculates an estimated PSC charge assuming that the remaining data is received in the PSC mode from the base station 7, while the CSC charge estimator block 19 calculates an estimated CSC charge assuming that the remaining data is received in the CSC mode from the base station 7.

At step 130, the comparator block 20 of the control section 2 compares the estimated PSC charge calculated by the PSC charge estimator block 13 and the estimated CSC charge calculated by the CSC charge estimator block 19. If the control section 2 determines that the estimated CSC charge is equal to or less than the estimated PSC charge, the process returns from step 130 to step 120 along the “YES” branch to execute the charge calculation process again. If the control section 2 determines that the estimated CSC charge is larger than the estimated PSC charge, the process proceeds from step 130 to step 140 along the “NO” branch.

At step 140, the control section 2 determines whether the current duration measured by the timer block 21 reaches one of the predetermined time lengths which are slightly less than integral multiples of the unit duration. If yes, the process proceeds to step 150. If not, the process returns to step 120.

At step 150, the control section 2 interrupts the communication section 6 to abort the CSC reception of the data signal. The control section 2 gives the communication section 6 a CSC call release instruction at step 160, and instructs the timer block 21 to terminate the measurement of the duration of the circuit-switched communication at step 170. In response to the CSC call release instruction, the communication section 6 clears the CSC call that has been established at step 80 between the communication section 6 and the base station 7.

At step 180, the control section 2 gives the communication section 6 a PSC call set-up instruction. In response to the PSC call set-up instruction, the communication section 6 establishes the PSC call between the communication section 6 and the base station 7. At step 190, the control section 2 instructs the communication section 6 to resume the reception of the data signal. Then the communication section 6 transmits a resume signal to the base station 7 in the PSC mode.

The base station 7 receives the resume signal, and then resumes transmitting the data signal to the PDA 1. In this case the base station 7 transmits the data signal according to the packet-switching system, since the PSC call has been established at step 180 between the PDA 1 and the base station 7. Then the control section 2 instructs the communication section 6 to receive the data signal in the PSC mode at step 200, and thereafter the process returns to step 40 so as to repeat the following steps. When the amount of the remaining data, which is indicated by the information acquired by the data amount acquisition block 11, vanishes, the process terminates.

According to the present embodiment, the following advantages are provided. The PDA 1 compares the estimated PSC charge and the estimated CSC charge in the middle of the reception of the data signal, and then selects, as a mode in which the PDA 1 operates for the moment, the PSC mode or the CSC mode based on the result of the comparison. Thus the PDA 1 receives the data signal switching between the PSC mode and the CSC mode, so that the user may obtain the content inexpensively.

Furthermore the estimated CSC charge is calculated using the information on the RSS, because there is every possibility that the PDA 1 (i.e., radio terminal) is used outdoors, that is, the RSS is prone to fluctuate. When the RSS is relatively low, the possible communication speed is relatively low. When the RSS is relatively high, the possible communication speed is relatively high. Therefore the PDA 1 can reliably estimate the CSC charge adapting to the fluctuation of the RSS.

Moreover the PDA 1 operates in the PSC mode, when it begins to receive the data signal. That is, the PDA 1 receives the information on the amount of the entire data in the PSC mode. This is preferable, because the amount of the information on the amount of the entire data is relatively small.

Further, if the PDA 1 determines that it is preferable that the PDA 1 switches to the PSC mode when the PDA 1 is in the CSC mode, the PDA 1 switches from the CSC mode to the PSC mode when the current duration of the circuit-switched communication reaches a time length slightly less than an integral multiple of the unit duration for measuring communication duration. That is, the switching from the CSC mode to the PSC mode is performed at an economically preferable time. Accordingly the user can obtain the content from the server 9 more inexpensively.

The present communication system employs the packet-switching system as a store-and-forward switching system. Therefore a store-and-forward switched communication (SSC) charge estimator means of the present invention corresponds to the PSC charge estimator block 13 of the present embodiment, and an SSC mode corresponds to the PSC mode.

Further program code for acquiring information on an amount of remaining data corresponds to the data amount acquisition block 11. Program code for calculating an estimated SSC charge corresponds to the PSC charge estimator block 13. Program code for calculating estimated communication duration corresponds to the duration estimator block 17. Program code for calculating an estimated CSC charge corresponds to the CSC charge estimator block 19. Program code for comparing the estimated SSC charge and the estimated CSC charge corresponds to the comparator block 20. Program code for acquiring information on received signal strength corresponds to the RSS acquisition block 14. Program code for calculating an estimated communication speed corresponds to the speed estimator block 16. Program code for measuring current duration of circuit-switched communication corresponds to the timer block 21.

A step for acquiring information on an amount of remaining data corresponds to step 330. A step for calculating an estimated SSC charge corresponds to step 340. A step for calculating estimated communication duration corresponds to step 370. A step for calculating an estimated CSC charge corresponds to step 380. A step for comparing the estimated SSC charge and the estimated CSC charge corresponds to steps 50 and 130. A step for selecting one of the SSC mode and the CSC mode and a step for setting the communication terminal in the selected mode together correspond to step 80, and further correspond to step 180. A step for acquiring information on received signal strength corresponds to step 350. A step for calculating an estimated communication speed corresponds to step 360. A step for measuring current duration of circuit-switched communication corresponds to step 90.

### Modifications

In the above embodiment, the communication terminal according to the present invention may be used as a cellular phone or an immobile terminal instead of the PDA 1. Further a frame relay switching system may be employed as a store-and-forward switching system instead of the packet switching system. Moreover, the PDA 1 may receive the data signal from the base station 7 according to File Transfer Protocol (FTP) instead of HTTP.

In the above embodiment, the PDA 1 receives the data signal from the server 9. However the PDA 1 may receive the data signal from another communication terminal. That is, the present invention may be applied to communication between two communication terminals. Further the PDA 1 may request information other than content to the server 9 or another communication terminal. That is, the PDA 1 may receive a data signal that includes information other than content.

Further in the above embodiment, the PDA 1 may receive the latest information on the communication rate and the communication speed from the server 9, and update the tables stored in the storages 12, 15, 18 using the received latest information immediately before the PDA 1 receives the data signal. Alternatively, the PDA 1 may obtain the latest version of the entire tables from the server 9 immediately before it receives the data signal. In this case the PDA 1 is not required to hold the tables in the storages 12, 15, 18.

In the above embodiment, if the PDA 1 can establish the PSC call and the CSC call between the PDA 1 and the base station 7 simultaneously, the control section 2 is not required to give the communication section 6 the PSC call release instruction at step 70 even when the PDA 1 determines that it is preferable that the PDA 1 switches from the PSC mode to the CSC mode. All the control section 2 has to do in this case is to interrupt the communication section 6 to abort the PSC reception of the data signal.

In the above embodiment, the programs for implementing the process shown in FIG. 3 may be stored in the storage section 5 when the PDA 1 is manufactured. However, the programs may be downloaded from a server to the PDA 1 by the user. Further the programs may be provided in the form of a storage medium such as a card memory which stores the programs, and installed on the PDA 1.

The present invention is not limited to the above embodiment and modifications, but may be variously embodied within the scope of the invention.

What is claimed is:

1. A communication terminal for receiving a data signal from a communication network, comprising:
data receiver means for receiving said data signal from said communication network in at least one of a store-and-forward switched communication (SSC) mode and a circuit-switched communication (CSC) mode;
data amount acquisition means for acquiring information on an amount of data of said data signal which is transmitted from said communication network;
SSC charge estimator means for calculating an estimated SSC charge based on a relationship between an amount of transferred data and a communication charge assuming that said data of the amount indicated by said information acquired by said data amount acquisition means is received from said communication network in the SSC mode;
duration estimator means for calculating estimated communication duration, which is time required for receiving said data of the amount indicated by said information acquired by said data amount acquisition means from said communication network in the CSC mode, based on a communication speed at which circuit-switched communication is performed between said data receiver means and said communication network;
CSC charge estimator means for calculating an estimated CSC charge corresponding to said estimated communication duration based on a relationship between communication duration and a communication charge; and
comparator means for comparing said estimated SSC charge and said estimated CSC charge, wherein said data receiver means is set in a communication mode which is selected from the SSC mode and the CSC mode based on a result of the comparison made by said comparator means.

2. A communication terminal as in claim 1 further comprising:
RSS acquisition means for acquiring information on received signal strength (RSS) at a time of reception of said data signal; and
speed estimator means for calculating an estimated communication speed using the RSS indicated by said information acquired by said RSS acquisition means based on a relationship between RSS and a possible communication speed, wherein said duration estimator means uses said estimated communication speed as said communication speed for calculating said estimated communication duration.

3. A communication terminal as in claim 1,
wherein said data receiver means is set in the SSC mode when it begins to receive said data signal from said communication network, so that an initial portion of said data signal is received in the SSC mode, and
wherein said data amount acquisition means uses information included in said initial portion of said data signal for acquiring said information on the amount of said data.

4. A communication terminal as in claim 1 further comprising timer means for measuring current duration of circuit-switched communication performed between said data receiver means and said communication network,
wherein, if said comparator means determines that said estimated SSC charge is less than said estimated CSC charge as the result of the comparison and said data receiver means is in the CSC mode, said data receiver means switches from the CSC mode to the SSC mode when said current duration measured by said timer means reaches a time length which is approximate to but less than an integral multiple of unit duration for measuring communication duration.

5. A communication system comprising:
a communication network; and
a communication terminal for receiving a data signal from said communication network, said communication terminal comprising:
data receiver means for receiving said data signal from said communication network in at least one of a store-and-forward switched communication (SSC) mode and a circuit-switched communication (CSC) mode;
data amount acquisition means for acquiring information on an amount of data of said data signal which is transmitted from said communication network;
SSC charge estimator means for calculating an estimated SSC charge based on a relationship between an amount of transferred data and a communication charge assuming that said data of the amount indicated by said information acquired by said data amount acquisition means is received from said communication network in the SSC mode;
duration estimator means for calculating estimated communication duration, which is time required for receiving said data of the amount indicated by said information acquired by said data amount acquisition means from said communication network in the CSC mode, based on a communication speed at which circuit-switched communication is performed between said data receiver means and said communication network;
CSC charge estimator means for calculating an estimated CSC charge corresponding to said estimated communication duration based on a relationship between communication duration and a communication charge; and
comparator means for comparing said estimated SSC charge and said estimated CSC charge, wherein said data receiver means is set in a communication mode which is selected from the SSC mode and the CSC mode based on a result of the comparison made by said comparator means.

6. A program for execution in control means of a communication terminal which receives a data signal from a communication network in at least one of a store-and-forward switched communication (SSC) mode and a circuit-switched communication (CSC) mode, said program comprising:
program code for acquiring information on an amount of data of said data signal which is transmitted from said communication network;
program code for calculating an estimated SSC charge based on a relationship between an amount of transferred data and a communication charge assuming that said data of the amount indicated by said acquired information is received in the SSC mode;
program code for calculating estimated communication duration, which is time required for receiving said data of the amount indicated by said acquired information in the CSC mode, based on a communication speed at which circuit-switched communication is performed between said communication terminal and said communication network;
program code for calculating an estimated CSC charge corresponding to said estimated communication duration based on a relationship between communication duration and a communication charge;
program code for comparing said estimated SSC charge and said estimated CSC charge;
program code for selecting one of the SSC mode and the CSC mode based on a result of the comparison of said estimated SSC charge and said estimated CSC charge; and
program code for setting said communication terminal in said selected one of the SSC mode and the CSC mode.

7. A program as in claim 6 further comprising:
program code for acquiring information on received signal strength (RSS) at a time of reception of said data signal; and
program code for calculating an estimated communication speed using said acquired information on the RSS based on a relationship between RSS and a possible communication speed, wherein said estimated communication speed is used as said communication speed for calculating said estimated communication duration.

8. A program as in claim 6,
wherein said communication terminal is set in the SSC mode when it begins to receive said data signal from said communication network, so that an initial portion of said data signal is received in the SSC mode, and
wherein information included in said initial portion of said data signal is used for acquiring said information on the amount of said data.

9. A program as in claim 6 further comprising program code for measuring current duration of circuit-switched communication performed between said communication terminal and said communication network,
wherein, if it is determined that said estimated SSC charge is less than said estimated CSC charge as the result of the comparison of said estimated SSC charge and said estimated CSC charge and said communication terminal is in the CSC mode, said communication terminal is switched from the CSC mode to the SSC mode when said measured current duration of the circuit-switched communication reaches a time length which is approximate to but less than an integral multiple of unit duration for measuring communication duration.

10. A method for switching between a store-and-forward switched communication (SSC) mode and a circuit-switched communication (CSC) mode in a communication terminal which receives a data signal via a communication network, said method comprising the steps of:
acquiring information on an amount of data of said data signal which is transmitted via said communication network;
calculating an estimated SSC charge based on a relationship between an amount of transferred data and a communication charge assuming that said communication terminal receives said data of the amount indicated by said acquired information in the SSC mode;
calculating estimated communication duration, which is time required for receiving said data of the amount indicated by said acquired information in the CSC mode, based on a communication speed at which circuit-switched communication is performed;
calculating an estimated CSC charge corresponding to said estimated communication duration based on a relationship between communication duration and a communication charge;
comparing said estimated SSC charge and said estimated CSC charge;
selecting one of the SSC mode and the CSC mode based on a result of the comparison of said estimated SSC charge and said estimated CSC charge; and
setting said communication terminal in said selected one of the SSC mode and the CSC mode.

11. A method as in claim 10 further comprising the steps of:
acquiring information on received signal strength (RSS) at a time of reception of said data signal; and
calculating an estimated communication speed using said acquired information on the RSS based on a relationship between RSS and a possible communication speed, wherein said estimated communication speed is used as said communication speed for calculating said estimated communication duration.

12. A method as in claim 10,
wherein said communication terminal is set in the SSC mode when it begins to receive said data signal from said communication network, so that an initial portion of said data signal is received in the SSC mode, and
wherein information included in said initial portion of said data signal is used for acquiring said information on the amount of said data.

13. A method as in claim 10 further comprising the step of measuring current duration of circuit-switched communication performed between said communication terminal and said communication network,
wherein, if it is determined that said estimated SSC charge is less than said estimated CSC charge as the result of the comparison of said estimated SSC charge and said estimated CSC charge and said communication terminal is in the CSC mode, said communication terminal is switched from the CSC mode to the SSC mode when said measured current duration of the circuit-switched communication reaches a time length which is approximate to but less than an integral multiple of unit duration for measuring communication duration.
